(19) United States
(12) Patent Application Publication
(10) Pub. No.: US 2024/0080270 A1
(43) Pub. Date: Mar. 7, 2024

(54) METHOD FOR AUTOMATICALLY REGULATING EXPLICIT CONGESTION NOTIFICATION OF DATA CENTER NETWORK BASED ON MULTI-AGENT REINFORCEMENT LEARNING

(71) Applicant: EAST CHINA NORMAL UNIVERSITY, Shanghai (CN)

(72) Inventors: Ting WANG, Shanghai (CN); Puyu CAI, Shanghai (CN); Kai CHENG, Shanghai (CN)

(21) Appl. No.: 18/454,705

(22) Filed: Aug. 23, 2023

(30) Foreign Application Priority Data
Sep. 7, 2022 (CN) 202211099120.2

(51) Int. Cl. H04L 47/11; H04L 47/12

(52) U.S. Cl. CPC H04L 47/115; H04L 47/12

(57) ABSTRACT

A method for automatically regulating an explicit congestion notification (ECN) of a data center network based on multi-agent reinforcement learning is provided. The method specifically includes steps 1 to 3. In step 1, an ECN threshold regulation of a data center network is modelled as a multi-agent reinforcement learning problem. In step 2, an independent proximal policy optimization (IPPO) algorithm in multi-agent reinforcement learning is used for training according to features of the data center network. In step 3, offline pre-training is combined with online incremental learning such that a model deployed on each switch is capable of rapidly adapting to a dynamic data center network environment.

### CROSS REFERENCE TO RELATED APPLICATION

This patent disclosure claims the benefit and priority of Chinese Patent Application No. 202211099120.2 filed with the China National Intellectual Property Administration on Sep. 7, 2022, the disclosure of which is incorporated by reference herein in its entirety as part of the present disclosure.

### TECHNICAL FIELD

The present disclosure belongs to the field of data center network congestion control, and in particular, relates to a method for automatically regulating an explicit congestion notification (ECN) threshold of a switch in a data center based on multi-agent reinforcement learning.

### BACKGROUND

With the advent of the cloud era, computing and storage have been gradually transferred to the cloud. As an essential infrastructure for cloud computing, a data center (DC) composed of a bulk of servers and network devices plays an increasingly important role in supporting strong computation and mass storage of individuals and enterprises. To meet the increasing cloud-based service needs, the number of servers in a DC increases sharply, which in turn requires a large number of network devices to form an interconnection system. This may eventually lead to rapid expansion of the scale of a data center network and extremely high complexity thereof. Therefore, how to provide effective congestion control (CC) in such a complex, dynamic, diversified large-scale data center network (DCN) to guarantee high-quality and responsive network services faces challenges mainly in the following three aspects.

In one aspect, a modern cloud data center is usually equipped with a large number of computing or data intensive applications, such as complex image processing, scientific computing, big data processing, distributed storage and artificial intelligence (AI) model training, thus spawning lots of distributed computing frameworks such as MapReduce, Spark and Flink to provide high performance computing. However, such a distributed computing paradigm continuously generates a great deal of many-to-one partition-wise aggregation mode traffic with high fan-in, which inevitably leads to an incast problem hard to handle, accompanied by continuous queue establishment, an increased delay, dithering and even data packet loss. Therefore, how to design an incast-aware congestion control scheme has become a problem urgently needing attention for a DCN.

In another aspect, as a diversified environment, a cloud data center usually provides various services that generate various types of traffic having different features and different requirements for network quality. For example, an elephant flow (e.g., data replication or virtual machine migration) running for a long time has an extremely high requirement for throughput, but a certain tolerance to network delay, which may be realized by setting a long queue on the side of a switch. In contrast, a short-lived mice flow (e.g., a control, management and query message) has a strict restriction on data packet delay, but rarely a requirement for throughput, which prefers a short queue length on the side of the switch. Therefore, how to adaptively adjust a queue length to simultaneously meet the needs of different types of traffic conflicts is still another key challenge.

Finally but also importantly, the DCN is regarded as a highly dynamic network environment, in which a traffic mode and proportions of large and small flows change rapidly, bringing about great uncertainty for a congestion control mechanism. This poses another challenge, i.e., how to enable a network congestion control strategy capable of self-learning and self-decision making to dynamically adapt to a real-time network environment.

An explicit congestion notification (ECN) has been recognized as an effective means for promoting network congestion control and has been widely supported by commercial switches of data centers. A setting strategy for an ECN marking threshold plays a vital role in determining the feasibility and the effectiveness of these existing ECN based congestion control schemes. Generally, strategies for setting an ECN marking threshold are mainly divided into the following three types: static setting, dynamic setting and automatic setting by self-learning. A static setting scheme requires that a fixed ECN marking threshold is configured to a switch in advance during the entire execution period of an algorithm. However, it is obvious that such static setting can neither adapt to a dynamic network environment nor simultaneously meet different needs of large and small flows. A high threshold may affect a delay sensitive mice flow, and a low threshold may lead to a bandwidth throughput decrease and even starvation for the elephant flow. In contrast, a dynamic scheme is capable of dynamically adjusting an ECN marking threshold based on some simple determination mechanisms. However, an adjustment strategy needs to be predefined manually and cannot be adjusted autonomously according to real-time network conditions. Worse, some of existing dynamic methods may adjust a threshold by considering only one simple factor (e.g., a link utilization rate or an instantaneous queue length), while some of them may be only applicable to a case of multiple queues. Reinforcement learning (RL) allows for dynamic decision making with a maximum reward through continuous interaction between an agent and an environment and provides an effective method for handling the above-mentioned problems. There are relatively few existing ECN regulating schemes based on reinforcement learning. In some studies, an appropriate strategy is generated according to observed statistics based on a reinforcement learning algorithm, and an ECN threshold is updated through a control interface of a switch. However, network environments cannot be fully understood such that learned strategies cannot always be optimal, especially in a case where incast and mixed large and small flows. Meanwhile, these algorithms may lead to memory overheads and bandwidth consumption to a certain extent, which are unrealistic and unacceptable for switches with limited resources.

### SUMMARY

In view of the problem that an ECN threshold regulating algorithm is poor in flexibility, incapable of adapting a highly dynamic network environment or cannot meet the needs of traffic with different features in the prior art, an objective of the present disclosure is to provide a method for automatically regulating an ECN of a data center network based on multi-agent reinforcement learning to dynamically adapt to a network environment and a rapidly changing traffic mode.

To achieve the above objective, the present disclosure adopts the following technical solutions.

A method for automatically regulating an ECN of a data center network based on multi-agent reinforcement learning includes steps 1 to 3:

In step 1, an ECN threshold regulation of a data center network is modelled as a multi-agent reinforcement learning problem; in the data center network, an ECN threshold is regulated by each switch to realize a balance between a time delay and a throughput; each switch in a data center is associated with an independent agent and a deep reinforcement learning framework is constructed in combination with a Markov decision process.

In step 2, each agent is trained by using an independent proximal policy optimization (IPPO) algorithm in multi-agent reinforcement learning according to network state information obtained in the deep reinforcement learning framework in combination with a designed reward function and an action space, thereby selecting an ECN threshold regulating strategy according to a dynamic network state.

In step 3, for each agent, a hybrid training strategy is used, and offline pre-training is combined with online incremental learning to improve overall quality of a model to adapt to a dynamically changing network state.

The associating each switch in a data center with an independent agent and constructing a deep reinforcement learning framework in combination with a Markov decision process in step 1 may specifically include: expressing the Markov decision process as a 5-tuple [symbol] =< [symbol] , [symbol] , [symbol] , [symbol] , γ>.

1) [symbol] represents a state space of the agent. In a data center scenario, state spaces are divided into two types: essential network environment features in the switch and network features obtained through simple calculation. The essential network environment features in the switch include a current queue length qlen, a data output rate txRate of each link, an output rate txRate^{(m)} of an ECN marking data packet and a current ECN threshold ECN^{(c)}. The network features obtained through simple calculation include an incast degree D_{incast} and a current ratio R_{flow} of large and small flows. For the incast degree, a sender and a receiver are determined according to header information of a data packet, and a total number of senders communicating with a same sender in each many-to-one traffic mode is calculated and output as the incast degree. For the current ratio of large and small flows, according to sizes of flows, a flow having a cumulative size larger than 1 MB is a large flow, a flow having a cumulative size less than or equal to 1 MB is a small flow. Then, a ratio of the large and small flows is calculated. Finally, network state information sₜ at time t is expressed by a 6-tuple: sₜ=(qlen, txRate, txRate^{(m)}, ECN^{(c)}, D_{incast}, R_{flow}). After the network state information sₜ is standardized, queue states at last k monitoring times are used as timing state information sₜ′ of each adjustment period: sₜ′={sₜ₋ₖ₊₁, . . . , sₜ₋₁, sₜ}∈ [symbol] .

2) [symbol] represents an action space of the agent. Actions of the agent are defined as ECN setting in an associated switch. ECN parameter settings in an active queue management (AQM) scheme are adopted, including a high marking threshold Kₘₐₓ, a low marking threshold Kₘᵢₙ and a marking probability Pₘₐₓ that is an action space aₜ is expressed as aₜ={Kₘₐₓ, Kₘᵢₙ, Pₘₐₓ}. A continuous action space is discretized, and an exponential function E(n)=α×2ⁿKB is used to determine discrete action values: Kₘᵢₙ and Kₘₐₓ, where α represents a scale parameter and n represents an output value of the agent, Kₘᵢₙ is guaranteed to be less than Kₘₐₓ in calculation. An adjustment interval for a discretization marking probability Pₘₐₓ is set as 5%; and, a time parameter Δt is set to limit a time interval between two adjacent adjustment operations, avoiding an adverse impact of frequent adjustments on the performance of the switch. 3) [symbol] represents the reward function. The reward function is a strategy for using a reward and punishment mechanism to optimize agent learning. A throughput and a data packet delay are characterized by using a locally observed link utilization rate and a queue length. The reward function is defined as r=β₁×T+β₂×Lₐ, where

$$T = \frac{txRate}{BW} ,$$

characterizing the link utilization rate, txRate represents an output rate of a link, and BW represents a total bandwidth of the link;

$${L}_{a} = \frac{1}{queueLength} ,$$

characterizing the delay with a reciprocal of an average queue length, where queueLength represents the average queue length; β₁ and β₂ are weighting parameters to balance weights of the throughput and the delay, and β₁+β₂=1.

4) [symbol] represents a transition probability; [symbol] (sₜ, aₜ) represents a transition probability from state sₜ to state sₜ₊₁ after act aₜ is performed in the tth adjustment. The transition probability is obtained after the agent is trained by a reinforcement learning algorithm.

5) γ represents a discount factor; and γ∈[0,1], which controls a preference degree of an immediate reward and a future reward. An objective of a reinforcement learning agent is to select an optimal action capable of obtaining a highest reward in each state so as to maximize a cumulative reward in a long time.

In step 2, the IPPO algorithm in multi-agent reinforcement learning is used for training. Multi-agent IPPO is an independent learning algorithm, where each distributed agent, namely a switch, is capable of independently learning and estimating a local value function thereof according to local state information of the agent, with no need for global experience replay. Specific description is as follows. Each switch independently performs the IPPO algorithm and learning, which may be expressed as parameterization of a value function V_{ω}(sₜ) with a learnable parameter ω using generalized advantage estimation, where ω represents the learnable parameter and sₜ represents state information at time t. Each switch has an advantage estimation function Âₜ, which is defined as: Âₜ=δₜ+(γλ)δₜ₊₁ + . . . +(γλ)^{T-t-1}δ_{T-1}, where δₜ=rₜ+γV_{ω}(sₜ₊₁)−V_{ω}(sₜ), V_{ω}(sₜ) represents a value at time t obtained through neural network estimation; ω represents the learnable parameter; sₜ represents the state information at time t; and γ represents the discount factor. A switch learning strategy is denoted by π, and a strategy loss function is expressed as follows:

$${L}_{r}^{π} ( θ ) = {𝔼}_{t} [ min ( \frac{{π}_{θ} ( {a}_{t} \vert {s}_{t} )}{{π}_{{θ}_{old}} ( {a}_{t} \vert {s}_{t} )} {Â}^{{π}_{θ}} ( {s}_{t} , {a}_{t} ) , clip ( \frac{{π}_{θ} ( {a}_{t} \vert {s}_{t} )}{{π}_{{θ}_{old}} ( {a}_{t} \vert {s}_{t} )} , 1 - ϵ , 1 + ϵ ) {Â}^{{π}_{θ}} ( {s}_{t} , {a}_{t} ) ) ] ,$$

where π_{θ}_{_{old}} represents a strategy parameterized by θ_{old}; π_{θ} represents a strategy parameterized by θ; clip represents a clip function; and ϵ represents an error value. Value estimation requires minimization of a squared error loss, which is specifically expressed as follows: Lₜ^{v}(ω)= [symbol] [(V_{ω}(sₜ₊₁)−\hat{R}ₜ)²], where \hat{R}ₜ represents a sum of rewards obtained from an environment from time t.

The using a hybrid training strategy for each agent and combining offline pre-training with online incremental learning in step 3 may specifically include following steps. During deployment, a model is firstly offline pre-trained according to collected historical network statistics to obtain an initial model. After the offline training, the initial model after pre-training is loaded to a switch such that the switch gradually trains a local model thereof online with local network state information, thereby improving the overall quality of the model. During the online training, a probability of selecting an exploration action, namely the discount factor γ exponentially attenuates, and an action generating a large reward is prioritized.

### Beneficial Effects of the Present Disclosure

Compared with the prior art, the present disclosure has the following advantages. The present disclosure allows for “zero-configuration” automatic ECN threshold regulation to respond to a dynamically changing data center network environment, and allows for easy deployment and has good compatibility with existing ECN based schemes. Moreover, a more reasonable, comprehensive and practical network environment quantification mechanism is designed; a plurality of key factors leading to congestion are taken into consideration, including the incast degree and the ratio of large and small flows; understanding of a network state by the algorithm is enhanced so that a more accurate ECN configuration strategy can be output to realize better performance of the data center. According to the present disclosure, based on the IPPO algorithm in multi-agent reinforcement learning, with a distributed design, immeasurable system overhead caused by experience replay is reduced while the state space is designed. Furthermore, the reward function is improved such that the model can better adapt to the optimization objective, increase a convergence speed and improve the robustness of the algorithm.

### BRIEF DESCRIPTION OF THE DRAWINGS

FIG. 1 is an overview diagram of a framework according to embodiments of the present disclosure.

### DETAILED DESCRIPTION OF THE EMBODIMENTS

The present disclosure will be described in detail below with reference to the accompanying drawings and an example. Apparently, the listed example only serves to explain the present disclosure, rather than to limit the scope of the present disclosure.

### Embodiment

A method for automatically regulating an ECN of a data center network based on multi-agent reinforcement learning in the present disclosure includes steps 1 to 3.

In step 1, ECN threshold regulation of a data center network is modelled as a multi-agent reinforcement learning problem; in the data center network, an ECN threshold is regulated by each switch to realize a balance between a time delay and a throughput; each switch in a data center is associated with an independent agent and a deep reinforcement learning framework is constructed in combination with a Markov decision process.

In step 2, each agent is trained by using an independent proximal policy optimization (IPPO) algorithm in multi-agent reinforcement learning according to network state information obtained in the deep reinforcement learning framework in combination with a designed reward function and an action space, thereby selecting an ECN threshold regulating strategy according to a dynamic network state.

In step 3, for each agent, a hybrid training strategy is used, and offline pre-training is combined with online incremental learning to improve overall quality of a model to adapt to a dynamically changing network state.

The associating each switch in a data center with an independent agent and constructing a deep reinforcement learning framework in combination with a Markov decision process in step 1 specifically include: expressing the Markov decision process as a 5-tuple [symbol] =< [symbol] , [symbol] , [symbol] , [symbol] , γ>.

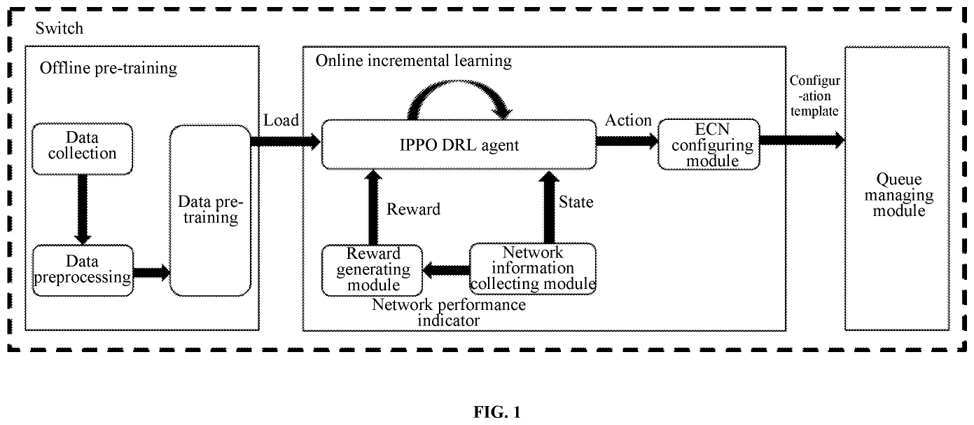

1) [symbol] represents a state space of the agent. In a data center scenario, state spaces are divided into two types: essential network environment features in the switch and network features obtained through simple calculation. The essential network environment features in the switch include a current queue length qlen, a data output rate txRate of each link, an output rate txRate^{(m)} of an ECN marking data packet and a current ECN threshold ECN^{(c)}. The network features obtained through simple calculation include an incast degree D_{incast} and a current ratio R_{flow} of large and small flows. For the incast degree, a sender and a receiver are determined according to header information of a data packet, and a total number of senders communicating with a same sender in each many-to-one traffic mode is calculated and output as the incast degree. For the current ratio of large and small flows, according to sizes of flows, a flow having a cumulative size larger than 1 MB is a large flow, a flow having a cumulative size less than or equal to 1 MB is a small flow. Then, a ratio of the large and small flows is calculated. Finally, network state information sₜ at time t is expressed by a 6-tuple: sₜ=(qlen, txRate, txRate^{(m)}, ECN^{(c)}, D_{incast}, R_{flow}). After the network state information sₜ is standardized, queue states at last k monitoring times are used as timing state information sₜ′ of each adjustment period: sₜ′={sₜ₋ₖ₊₁, . . . , sₜ₋₁, sₜ}∈ [symbol] . In FIG. 1, a network information collecting module collects state information and provide the state information to the agent for processing.

2) [symbol] represents an action space of the agent. Actions of the agent are defined as ECN setting in an associated switch. ECN parameter settings in an active queue management (AQM) scheme are adopted, including a high marking threshold Kₘₐₓ, a low marking threshold Kₘᵢₙ and a marking probability Pₘₐₓ, that is an action space aₜ is expressed as aₜ={Kₘₐₓ, Kₘᵢₙ, Pₘₐₓ}. A continuous action space is discretized, and an exponential function E(n)=α×2ⁿKB is used to determine discrete action values: Kₘᵢₙ and Kₘₐₓ, where α represents a scale parameter and n represents an output value of the agent, Kₘᵢₙ is guaranteed to be less than Kₘₐₓ in calculation. An adjustment interval for a discretization marking probability Pₘₐₓ is set as 5%; and, a time parameter Δt is set to limit a time interval between two adjacent adjustment operations, avoiding an adverse impact of frequent adjustments on the performance of the switch. In FIG. 1, the agent provides a generated action strategy for an ECN configuring module to generate an ECN configuration template and finally provides the ECN configuration template for a queue managing module for deploying ECN configuration.

3) [symbol] represents the reward function. The reward function is a strategy for using a reward and punishment mechanism to optimize agent learning. A throughput and a data packet delay are characterized by using a locally observed link utilization rate and a queue length. The reward function is defined as r=β₁×T+β₂×Lₐ, where

$$T = \frac{txRate}{BW} ,$$

characterizing the link utilization rate, txRate represents an output rate of a link, and BW represents a total bandwidth of the link;

$${L}_{a} = \frac{1}{queueLength} ,$$

characterizing the delay with a reciprocal of an average queue length, where queueLength represents the average queue length; β₁ and β₂ are weighting parameters to balance weights of the throughput and the delay, and β₁+β₂=1. In FIG. 1, a reward generating module obtains a network performance indicator from the network information collecting module and generates a reward to be fed back to the agent.

4) [symbol] represents a transition probability. [symbol] (sₜ, aₜ) represents a transition probability from state sₜ to state sₜ₊₁ after act aₜ is performed in the tth adjustment. The transition probability is obtained after the agent is trained by a reinforcement learning algorithm. In FIG. 1, the parameter in the DRL agent represents the transition probability.

5) γ represents a discount factor; and γ∈[0,1], which controls a preference degree of an immediate reward and a future reward. An objective of a reinforcement learning agent is to select an optimal action capable of obtaining a highest reward in each state so as to maximize a cumulative reward in a long time.

In step 2, the IPPO algorithm in multi-agent reinforcement learning is used for training. Multi-agent IPPO is an independent learning algorithm, where each distributed agent, namely a switch, is capable of independently learning and estimating a local value function thereof according to local state information of the agent, with no need for global experience replay. Specific description is as follows: each switch independently performs the IPPO algorithm and learning, which may be expressed as parameterization of a value function V_{ω}(sₜ) with a learnable parameter ω using generalized advantage estimation, where ω represents the learnable parameter and sₜ represents state information at time t. Each switch has an advantage estimation function Âₜ, which is defined as: Âₜ=δₜ+(γλ)δₜ₊₁ + . . . +(γλ)^{T-t-1}δ_{T-1}, where δₜ=rₜ+γV_{ω}(sₜ₊₁)−V_{ω}(sₜ), V_{ω}(sₜ) represents a value at time t obtained through neural network estimation; ω represents the learnable parameter; sₜ represents the state information at time t; and γ represents the discount factor. A switch learning strategy is denoted by π, and a strategy loss function is expressed as follows:

$${L}_{r}^{π} ( θ ) = {𝔼}_{t} [ min ( \frac{{π}_{θ} ( {a}_{t} \vert {s}_{t} )}{{π}_{{θ}_{old}} ( {a}_{t} \vert {s}_{t} )} {Â}^{{π}_{θ}} ( {s}_{t} , {a}_{t} ) , clip ( \frac{{π}_{θ} ( {a}_{t} \vert {s}_{t} )}{{π}_{{θ}_{old}} ( {a}_{t} \vert {s}_{t} )} , 1 - ϵ , 1 + ϵ ) {Â}^{{π}_{θ}} ( {s}_{t} , {a}_{t} ) ) ] ,$$

where π_{θ}_{_{old}} represents a strategy parameterized by θ_{old}; π_{θ} represents a strategy parameterized by θ; clip represents a clip function; and ϵ represents an error value. Value estimation requires minimization of a squared error loss, which is specifically expressed as follows: Lₜ^{v}(ω)= [symbol] ₜ[(V_{ω}(sₜ₊₁)−\hat{R}ₜ)²], where \hat{R}ₜ represents a sum of rewards obtained from an environment from time t.

The using a hybrid training strategy for each agent and combining offline pre-training with online incremental learning in step 3 specifically includes following steps. Deployment on the switch is divided into two phases: an offline pre-training phase and an online incremental learning phase. In the offline pre-training phase, three steps are involved: firstly, data (which is mainly historical network statistics) needs to be collected; secondly, the collected data is preprocessed; and finally, a model is pre-trained according to the preprocessed data to obtain an initial model. In the online incremental learning phase, the initial model subjected to the pre-training phase is loaded onto the switch. At this time, the switch becomes an IPPO DRL agent and performs online incremental learning. During the online incremental learning, firstly, the network information collecting module collects the state information of a network and provides the state to the DRL agent. The agent outputs an action according to the model and provides the action to the ECN configuring module. The ECN configuring module generates a configuration template according to the output action and provides the configuration template to the queue managing module for deploying ECN configuration. At this time, a probability of selecting an exploration action, namely the discount factor y exponentially attenuates, and an action generating a large reward is prioritized. Moreover, the network information collecting module provides the network performance indicator part in the collected network state information for the reward generating module, and the reward generating module generates a reward to be fed back to the DRL agent for strategy optimization.

What is claimed is:

1. A method for automatically regulating an explicit congestion notification (ECN) of a data center network based on multi-agent reinforcement learning, comprising following steps:
step 1, modeling ECN threshold regulation of a data center network as a multi-agent reinforcement learning problem; regulating, by each switch in the data center network, an ECN threshold to realize a balance between a time delay and a throughput; associating each switch in a data center with an independent agent and constructing a deep reinforcement learning framework in combination with a Markov decision process;
step 2, training each agent by using an independent proximal policy optimization (IPPO) algorithm in multi-agent reinforcement learning according to network state information obtained in the deep reinforcement learning framework in combination with a designed reward function and an action space, thereby selecting an ECN threshold regulating strategy according to a dynamic network state; and
step 3, using a hybrid training strategy for each agent, and combining offline pre-training with online incremental learning to improve overall quality of a model to adapt to a dynamically changing network state.

2. The method according to claim 1, wherein the associating each switch in a data center with an independent agent and constructing a deep reinforcement learning framework in combination with a Markov decision process in step 1 comprise: expressing the Markov decision process as a 5-tuple [symbol] =< [symbol] , [symbol] , [symbol] , [symbol] , γ>, wherein [symbol]
represents state spaces of the agent; in a data center scenario, the state spaces are divided into two types: essential network environment features in the switch and network features obtained through simple calculation, wherein the essential network environment features in the switch comprises a current queue length qlen, a data output rate txRate of each link, an output rate txRate^{(m)} of an ECN marking data packet and a current ECN threshold ECN^{(c)}; the network features obtained through simple calculation comprises an incast degree D_{incast} and a current ratio R_{flow} of large and small flows; for the incast degree, a sender and a receiver are determined according to header information of a data packet, and a total number of senders communicating with a same sender in each many-to-one traffic mode is calculated and output as the incast degree; for the current ratio of large and small flows, according to sizes of flows, a flow having a cumulative size larger than 1 MB is a large flow, a flow having a cumulative size less than or equal to 1 MB is a small flow; then, a ratio of the large and small flows is calculated; finally, network state information sₜ at time t is expressed by a 6-tuple: sₜ=(qlen, txRate, txRate^{(m)}, ECN^{(c)}, D_{incast}, R_{flow}); and after the network state information sₜ is standardized, queue states at last k monitoring times are used as timing state information sₜ′ of each adjustment period: sₜ′={sₜ₋ₖ₊₁, . . . , sₜ₋₁, sₜ}∈ [symbol] ; [symbol]
represents an action space of the agent; actions of the agent are defined as ECN setting in an associated switch; ECN parameter settings in an active queue management (AQM) scheme are adopted, comprising a high marking threshold Kₘₐₓ, a low marking threshold Kₘᵢₙ and a marking probability Pₘₐₓ, and an action space aₜ is expressed as aₜ {Kₘₐₓ, Kₘᵢₙ, Pₘₐₓ}; a continuous action space is discretized, and an exponential function E(n)=α×2ⁿKB is used to determine discrete action values: Kₘᵢₙ and Kₘₐₓ, wherein α represents a scale parameter and n represents an output value of the agent, Kₘᵢₙ is guaranteed to be less than Kₘₐₓ in calculation; an adjustment interval for a discretization marking probability Pₘₐₓ is set as 5%; and, a time parameter Δt is set to limit a time interval between two adjacent adjustment operations, avoiding an adverse impact of frequent adjustments on performance of the switch; [symbol]
represents the reward function; the reward function is a strategy for using a reward and punishment mechanism to optimize agent learning; a throughput and a data packet delay are characterized by using a queue length and a link utilization rate locally observed; the reward function is defined as r=β₁×T+β₂×Lₐ, wherein
$$T = \frac{txRate}{BW} ,$$
characterizing the link utilization rate, txRate represents an output rate of a link, and BW represents a total bandwidth of the link;
$${L}_{a} = \frac{1}{queueLength} ,$$
characterizing the delay with a reciprocal of an average queue length, wherein queueLength represents the average queue length; β₁ and β₂ are weighting parameters to balance weights of the throughput and the delay, and β₁+β₂=1; [symbol]
represents a transition probability; [symbol] (sₜ , aₜ) represents a transition probability from state sₜ to state sₜ₊₁ after act aₜ is performed in the tth adjustment; and the transition probability is obtained after the agent is trained by a reinforcement learning algorithm;
γ represents a discount factor; and γ∈[0,1], which controls a preference degree between an immediate reward and a future reward; and an objective of a reinforcement learning agent is to select an optimal action capable of obtaining a highest reward in each state so as to maximize a cumulative reward in a long time.

3. The method according to claim 1, wherein for the training by using an IPPO algorithm in multi-agent reinforcement learning in step 2, multi-agent IPPO is an independent learning algorithm, wherein each distributed agent, namely each switch, is capable of independently learning and estimating a local value function thereof according to local state information of the distributed agent with no need for global experience replay; specific description is as follows: each switch independently performs the IPPO algorithm and learning, which is expressed as parameterization of a value function V_{ω}(sₜ) with a learnable parameter ω using generalized advantage estimation, wherein ω represents the learnable parameter and sₜ represents state information at time t; each switch has an advantage estimation function Âₜ, which is defined as: Âₜ=δₜ+(γλ)δₜ₊₁ + . . . +(γλ)^{T-t-1}δ_{T-1}, wherein δₜ=rₜ+γV_{ω}(sₜ₊₁)−V_{ω}(sₜ), V_{ω}(sₜ) represents a value at time t obtained through neural network estimation; ω represents the learnable parameter; sₜ represents the state information at time t; and γ represents the discount factor; a switch learning strategy is denoted by π, and a strategy loss function is expressed as:
$${L}_{r}^{π} ( θ ) = {𝔼}_{t} [ min ( \frac{{π}_{θ} ( {a}_{t} \vert {s}_{t} )}{{π}_{{θ}_{old}} ( {a}_{t} \vert {s}_{t} )} {Â}^{{π}_{θ}} ( {s}_{t} , {a}_{t} ) , clip ( \frac{{π}_{θ} ( {a}_{t} \vert {s}_{t} )}{{π}_{{θ}_{old}} ( {a}_{t} \vert {s}_{t} )} , 1 - ϵ , 1 + ϵ ) {Â}^{{π}_{θ}} ( {s}_{t} , {a}_{t} ) ) ] ,$$
wherein π_{θ}_{_{old}} represents a strategy parameterized by θ_{old}; π_{θ} represents a strategy parameterized by θ; clip represents a clip function; and ϵ represents an error value; and value estimation requires minimization of a squared error loss, which is expressed as follows: Lₜ^{v}(ω)= [symbol] ₜ[(V_{ω}(sₜ₊₁)−\hat{R}ₜ)²], wherein \hat{R}ₜ represents a sum of rewards obtained from an environment from time t.

4. The method according to claim 1, wherein the using a hybrid training strategy for each agent and combining offline pre-training with online incremental learning in step 3 comprise:
during deployment, firstly pre-training a model offline according to collected historical network statistical data to obtain an initial model; and after the offline training, loading the pre-trained initial model to a switch such that the switch gradually trains a local model thereof online with local network state information, thereby improving overall quality of the model, wherein during the online training, a probability of selecting an exploration action, namely the discount factor γ exponentially attenuates, and an action generating a large reward is prioritized.
